(19) United States
(12) Patent Application Publication
(10) Pub. No.: US 2010/0060974 A1
(43) Pub. Date: Mar. 11, 2010

(54) Color Display Device

(76) Inventors: Yi-Ching WANG, Hsinchu City (TW); Tzu Ming Wang, Hsinchu City (TW)

Correspondence Address: HDLS Patent & Trademark Services, P.O. BOX 220746, CHANTILLY, VA, 20153-0746, US

(21) Appl. No.: 12/277,358

(22) Filed: Nov. 25, 2008

(30) Foreign Application Priority Data
Sep. 11, 2008 (TW) 097134817

(51) Int. Cl. G02F 1/167; G02F 1/23

(52) U.S. Cl. 359/296; 359/290

(57) ABSTRACT

A color display device includes a substrate, a protecting layer, an electrophoretic display module, an electrowetting display module and a first insulating layer. The protecting layer is opposite to the substrate, and the protecting layer is made of a transparent material and the first insulating layer is made of a transparent material. The electrophoretic display module is arranged between the substrate and the protecting layer, and is a monochrome display module. The electrowetting display module is arranged between the substrate and the protecting layer, and is a color display module. The first insulating layer is arranged between the electrophoretic display module and the electrowetting display module. The color display device has high color saturation and high contrast.

### BACKGROUND

1. Field of the Invention

The present invention relates to a display device, and more particularly to a color display device.

2. Description of the Related Art

With the rapid development of the display technology, flat display devices have been widely used in various display fields increasingly. Since electrophoretic display devices have advantages of low power-consumption, high reflectivity and high contrast, etc., they have been a more and more important flat display device.

Currently, a conventional electrophoretic display device generally includes an electrophoretic display layer arranged between two electrode layers. The electrophoretic display layer includes a plurality of charged particles. The colors of the charged particles generally include black and white wherein the black charged particles and the white charged particles have different electric properties. When an electric field is applied between the electrode layers, the black charged particles and the white charged particles are driven to move in different directions, such that each of pixels of the electrophoretic display device displays black or white. Since each of the pixels of the conventional electrophoretic display device only can display black or white, the conventional electrophoretic display device cannot achieve colorization.

To solve the above problem, a color filter is generally disposed on the electroporetic display device such that the electrophoretic display device can achieve colorization. However, the color filter absorbs light rays, such that the light utilization efficiency of the electrophoretic display device is reduced, and the brightness, the contrast and the color saturation of the electrophoretic display device, especially the color saturation thereof, are greatly reduced.

On the other hand, the conventional technology develops an electrowetting display device, which is a color display device. However, black images displayed by the electrowetting display device are not dark enough. In other words, the contrast of the electrowetting display device is bad.

### BRIEF SUMMARY

The present invention relates to a color display device having high color saturation.

The present invention also relates to a color display device to improve color saturation.

To achieve the above advantages, a color display device in accordance with an exemplary embodiment of the present invention is provided. The color display device comprises a substrate, a protecting layer, an electrophoretic display module, an electrowetting display module and a first insulating layer. The protecting layer is opposite to the substrate, and the protecting layer is made of a transparent material and the first insulating layer is made of a transparent material. The electrophoretic display module is arranged between the substrate and the protecting layer, and the electrophoretic display module is a monochrome display module. The electrowetting display module is arranged between the substrate and the protecting layer, and the electrowetting display module is a color display module. The first insulating layer is arranged between the electrophoretic display module and the electrowetting display module.

In an embodiment of the present invention, the electrophoretic display module is disposed on the substrate, and the electrowetting display module is arranged between the first insulating layer and the protecting layer.

In an embodiment of the present invention, the electrophoretic display module comprises a first driving circuit layer, an electrophoretic display layer and a first transparent electrode layer. The first driving circuit layer is disposed on the substrate. The electrophoretic display layer is disposed on the first driving circuit layer. The first transparent electrode layer is arranged between the electrophoretic display layer and the first insulating layer.

In an embodiment of the present invention, the electrophoretic display layer is a microcapsule electrophoretic display layer or a microcup electrophoretic display layer.

In an embodiment of the present invention, the electrowetting display module comprises a second driving circuit layer, a second insulating layer, a hydrophobic layer, an electrowetting display layer and a second transparent electrode layer. The second driving circuit layer is disposed on the first insulating layer. The second insulating layer is disposed on the second driving circuit layer. The hydrophobic layer is disposed on the second insulating layer. The electrowetting display layer is disposed on the hydrophobic layer. The second transparent electrode layer is arranged between the electrowetting display layer and the protecting layer.

In an embodiment of the present invention, the electrowetting display layer comprises a matrix layer, a plurality of polar solvents and a plurality of color pigments. The matrix layer is disposed on the hydrophobic layer to form a plurality of pixel regions on the hydrophobic layer. The matrix layer is made of a hydrophilic material. The polar solvents are disposed in the pixel regions. The color pigments are disposed in the pixel regions, and the color pigments are not soluble in the polar solvents.

In an embodiment of the present invention, the electrowetting display layer further comprises a plurality of partition walls disposed in the pixel regions to divide each of the pixel regions into a plurality of sub-pixel regions. Each of the sub-pixel regions has at least one of the color pigments with same color, and colors of the color pigments of the sub-pixel regions of each of the pixel regions are different.

In an embodiment of the present invention, the colors of the color pigments of the sub-pixel regions of each of the pixel regions comprise red, blue and green.

In an embodiment of the present invention, the colors of the color pigments of the sub-pixel regions of each of the pixel regions comprise yellow, cyan and magenta.

In an embodiment of the present invention, the second driving circuit layer comprises a plurality of driving elements and a plurality of sub-pixel electrodes, and the sub-pixel electrodes are transparent electrodes.

In an embodiment of the present invention, the substrate is a rigid substrate or a flexible substrate.

In an embodiment of the present invention, the protecting layer is a protecting film or a rigid substrate.

To achieve the above advantages, a color display device in accordance with another exemplary embodiment of the present invention is provided. The color display device comprises a substrate, a protecting layer, a monochrome electrophoretic display module, a color electrophoretic display module and an insulating layer. The protecting layer is opposite to the substrate, the protecting layer is made of a transparent material and the insulating layer is made of a transparent material. The monochrome electrophoretic display module is arranged between the substrate and the protecting layer. The color electrophoretic display module is arranged between the substrate and the protecting layer. The insulating layer is arranged between the monochrome electrophoretic display module and the color electrophoretic display module.

In an embodiment of the present invention, the monochrome electrophoretic display module is a microcapsule electrophoretic display module, and the color electrophoretic display module is a microcup electrophoretic display module.

In an embodiment of the present invention, the color electrophoretic display module comprises a driving circuit layer, an electrophoretic display layer and a transparent electrode layer. The driving circuit layer is disposed on the insulating layer. The electrophoretic display layer is disposed on the driving circuit layer. The transparent electrode layer is arranged between the electrophoretic display layer and the protecting layer. In addition, the electrophoretic display layer comprises a plurality of partition walls, a plurality of insulating solvents and a plurality of color charged particles. The partition walls are disposed on the driving circuit layer to form a plurality of pixel regions on the driving circuit layer, and each of the pixel regions comprises a plurality of sub-pixel regions. The insulating solvents are disposed in the pixel regions. The color charged particles are dispersed into the insulating solvents disposed in the pixel regions. Each of the sub-pixel regions has at least one of the color charged particles with same color disposed therein, and colors of the color charged particles of the sub-pixel regions of each of the pixel regions are different.

In an embodiment of the present invention, the color electrophoretic display module further comprises a plurality of side electrode sets disposed in the sub-pixel regions of each of the pixel regions respectively. Each of the side electrode sets includes a first electrode and a second electrode arranged on the partition walls respectively, and the first electrode is opposite to the second electrode.

In an embodiment of the present invention, the colors of the color charged particles comprise red, blue and green.

In an embodiment of the present invention, the colors of the color charged particles comprise yellow, cyan and magenta.

In an embodiment of the present invention, the monochrome electrophoretic display module is disposed on the substrate, and the color electrophoretic display module is arranged between the insulating layer and the protecting layer.

In an embodiment of the present invention, the substrate is a rigid substrate or a flexible substrate, and the protecting layer is a rigid substrate or a protecting film.

One color display device of the present invention employs the electrowetting display module as the color display module, and does not employ the color filter. Therefore, the color saturation of the color display device of the present invention can be improved. In addition, another color display device of the present invention employs the color electrophoretic display module as the color display module, and does not employ the color filter. Therefore, the color display device has high color saturation.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view of a color display device in accordance with a first exemplary embodiment of the present invention.

FIG. 2 is a schematic view of a color display device in accordance with a second exemplary embodiment of the present invention.

FIG. 3 is a schematic view of a color display device in accordance with a third exemplary embodiment of the present invention.

### DETAILED DESCRIPTION

Reference will now be made to the drawings to describe exemplary embodiments of the present color display device, in detail. The following description is given by way of example, and not limitation.

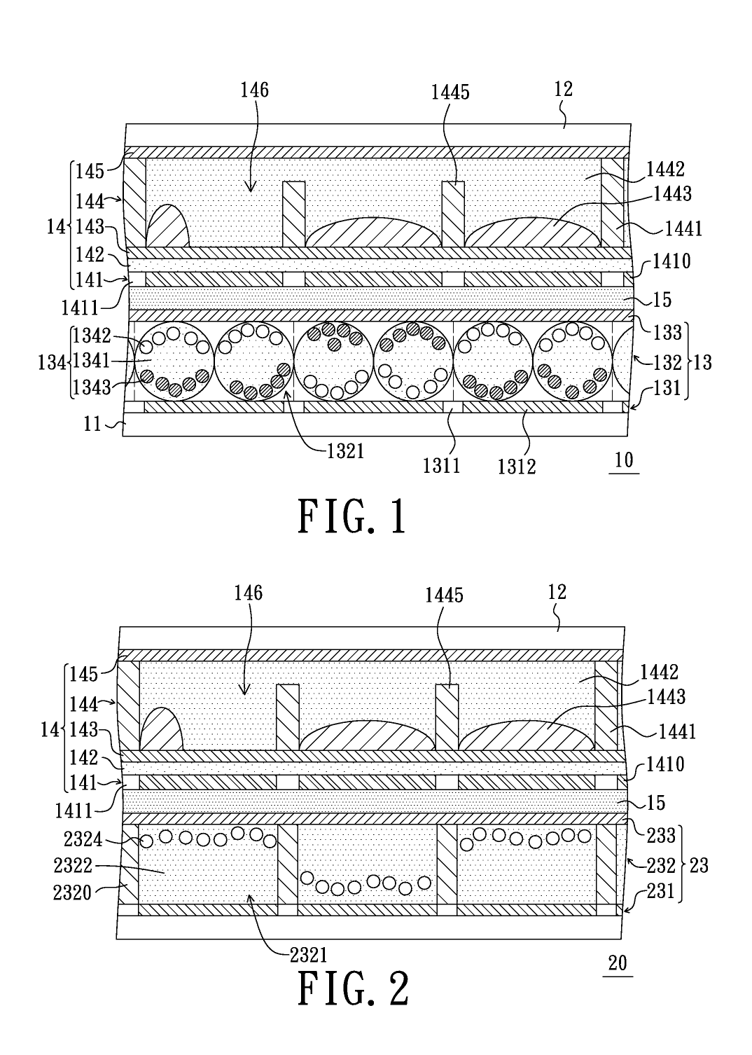

FIG. 1 is a schematic view of a color display device in accordance with a first exemplary embodiment of the present invention. FIG. 1 only shows one of pixels of the color display device. Referring to FIG. 1, the color display device 10 includes a substrate 11, a protecting layer 12, an electrophoretic display module 13, an electrowetting display module 14 and a first insulating layer 15.

The protecting layer 12 is opposite to the substrate 11. The electrophoretic display module 13 and the electrowetting module 14 are disposed between the substrate 11 and the protecting layer 12, wherein the electrophoretic display module 13 is a monochrome display module, and the electrowetting display module 14 is a color display module. The first insulating layer 15 is arranged between the electrophoretic display module 13 and the electrowetting display module 14 to insulate the electrophoretic display module 13 and the electrowetting display module 14. The first insulating layer 15 is made of a transparent material, such as glass or plastic. More specifically, the material of the first insulating layer 15 may include polyethylene terephthalate (PET), polyethylene naphthenate (PEN), polyaramid (PA), polyimide (PI), polycycloolefin, polysulfone, epoxy, polycarbonate (PC) or polymethylmethacrylate (PMMA). The substrate 11 may be a rigid substrate or a flexible substrate. The protecting layer 12 may be a protecting film or a rigid substrate, and the protecting layer 12 is made of a transparent material, such as glass or plastic. More specifically, the material of the protecting layer 12 may include polyethylene terephthalate, polyethylene naphthenate, polyaramid, polyimide, polycycloolefin, polysulfone, epoxy, polycarbonate or polymethylmethacrylate. Furthermore, the electrophoretic display module 13 may be disposed on the substrate 11, and the electrowetting display module 14 may be arranged between the first insulating layer 15 and the protecting layer 12.

The electrophoretic display module 13 includes a first driving circuit layer 131, an electrophoretic display layer 132 and a first transparent electrode layer 133. The first driving circuit layer 131 is disposed on the substrate 11, the electrophoretic display layer 132 is disposed on the first driving circuit layer 131, and the first transparent electrode layer 133 is arranged between the electrophoretic display layer 132 and the first insulating layer 15. The first transparent electrode layer 133 includes a plurality of electrodes and may be made of a transparent conductive material, and the transparent conductive material may be indium tin oxide (ITO), indium zinc oxide (IZO), zinc oxide (ZnO) or indium gallium zinc oxide (IGZO), etc. The first driving circuit layer 131 may include a plurality of driving elements 1311 (such as thin film transistors) and a plurality of sub-pixel electrodes 1312. Electric fields for driving the electrophoretic display layer 132 are generated between the sub-pixel electrodes 1312 and the transparent electrode layer 133. The electrophoretic display layer 132 can be, but not limited to, a microcapsule electrophoretic display layer or a microcup electrophoretic display layer. In this exemplary embodiment, the electrophoretic display layer 132 is a microcapsule electrophoretic display layer.

More specifically, the electrophoretic display layer 132 includes a plurality of microcapsules 134. Each of the microcapsules 134 may include an insulating solvent 1341 filled in the microcapsule 134, a plurality of first charged particles 1342 and a plurality of second charged particles 1343. The first charged particles 1342 and the second charged particles 1343 are dispersed into the insulating solvent 1341. The first charged particles 1342 are white particles, and the second charged particles 1343 are black particles. The first charged particles 1342 and the second charged particles 1343 filled in the microcapsule 134 are driven to move according to the electric fields applied to the electrophoretic display layer 132.

When the first charged particles (white particles) 1342 of one of the sub-pixel regions 1321 of the electrophoretic display layer 132 move to near the first transparent electrode layer 133, the first charged particles 1342 reflect light rays, such that the corresponding sub-pixel region 1321 displays white. When the second charged particles (black particles) 1343 of one of the sub-pixel regions 1321 of the electrophoretic display layer 132 move to near the first transparent electrode layer 133, the second charged particles 1343 absorb light rays, such that the corresponding sub-pixel region 1321 displays black. Therefore, the electrophoretic display module 13 is a monochrome display module.

The electrowetting display module 14 includes a second driving circuit layer 141, a second insulating layer 142, a hydrophobic layer 143, an electrowetting display layer 144 and a second transparent electrode layer 145.

The second driving circuit layer 141 is disposed on the first insulating layer 15, and includes a plurality of driving elements 1411 (such as thin film transistors) and a plurality of sub-pixel electrodes 1410. The sub-pixel electrodes 1410 are transparent electrodes, and the sub-pixel electrodes 1410 may be made of a transparent conductive material, such as indium tin oxide or indium zinc oxide, etc. The second insulating layer 142 is disposed on the second driving circuit layer 141. The hydrophobic layer 143 is disposed on the second insulating layer 142. The electrowetting display layer 144 is disposed on the hydrophobic layer 143. The second transparent electrode layer 145 is arranged between the electrowetting display layer 144 and the protecting layer 12, and the second transparent electrode layer 145 may be made of a transparent conductive material, such as indium tin oxide or indium zinc oxide, etc.

The electrowetting display layer 144 includes a matrix layer 1441, a plurality of polar solvents 1442 and a plurality of color pigments 1443. The matrix layer 1441 is disposed on the hydrophobic layer 143 to form a plurality of pixel regions on the hydrophobic layer 143. For the explanation's convenience, FIG. 1 only shows a pixel region.

The matrix layer 1441 is made of a hydrophilic material. Each of the polar solvents 1442 may be water, and is disposed in one of the pixel regions. The color pigments 1443 are disposed in the pixel regions respectively, and the color pigments 1443 are not soluble in the polar solvents 1442.

The electrowetting display layer 144 may further include a plurality of partition walls 1445, which are arranged in the pixel regions to form a plurality of sub-pixel regions 146 on each of the pixel regions. Each of the sub-pixel regions 146 has at least one of the color pigments 1443 with same color arranged therein, and the colors of the color pigments 1443 arranged in the sub-pixel regions 146 of each of the pixel regions are different. More specifically, the colors of the color pigments 1443 arranged in the sub-pixel regions 146 of each of the pixel regions may include red, blue and green. In other words, each of the pixel regions includes a red sub-pixel region 146, a blue sub-pixel region 146 and a green sub-pixel region 146. In another exemplary embodiment of the present invention, the colors of the color pigments 1443 arranged in the sub-pixel regions 146 of each pixel region may include yellow, cyan and magenta. In other words, each of the pixel regions includes a yellow sub-pixel region 146, a cyan sub-pixel region 146 and a magenta sub-pixel region 146.

When an electric field is applied between the sub-pixel electrode 1410 of one of the pixel regions 146 and the second transparent electrode layer 145, the surface tension of the contact surface between the color pigment 1443 and the hydrophobic layer 143 will be changed, and thus the size of the color pigment 1443 is reduced and the color pigment 1443 is moved to a corner of the sub-pixel region 146 by the polar solvent 1442. Therefore, the sub-pixel region 1321 of the electrophoretic display module 13 below the sub-pixel region 146 is exposed. In other words, when the size of the color pigment 1443 in one of the pixel regions 146 is reduced and moved to a corner of the sub-pixel region 146, white or black is displayed. In addition, when no electric field is applied, the color of the color pigment 1443 in each of sub-pixel regions 146 will be displayed.

Compared with the prior art, the color display device 10 of the present embodiment does not need a color filter, but employs the electrophoretic display module 13 having an advantage of low power consumption as the monochrome display module and employs the electrowetting display module 14 having an advantage of high color saturation as the color display module. Therefore, the light utilization efficiency of the color display device 10 of the present embodiment can be greatly improved, and the color saturation and the contrast thereof are increased.

FIG. 2 is a schematic view of a color display device in accordance with a second exemplary embodiment of the present invention. FIG. 2 only shows a pixel structure of the color display device. Referring to FIG. 2, the color display device 20 is similar to the color display device 10 of the first exemplary embodiment, except that the electrophoretic display layer 232 of the electrophoretic display module 23 of the color display device 20 is a microcup electrophoretic display layer.

More specifically, the electrophoretic display layer 232 may include a plurality of partition walls 2320. The partition walls 2320 are arranged between the first driving circuit layer 231 and the first transparent electrode layer 233 of the electrophoretic display module 23 to divide the electrophoretic display layer 232 into a plurality of sub-pixel regions 2321. Each of the sub-pixel regions 2321 includes an insulating solvent 2322 filled therein and a plurality of charged particles 2324. The charged particles 2324 are dispersed in the insulating solvent 2322. The insulating solvent 2322 may be a black solvent, and the charged particles 2324 may be white particles.

When the charged particles 2324 in one of the sub-pixel regions 2321 of the electrophoretic display layer 232 is moved to a side adjacent to the first transparent electrode layer 233, the charged particles 2324 reflect light rays such that the corresponding sub-pixel region 2321 displays white. When the charged particles 2324 in one of the sub-pixel regions 2321 of the electrophoretic display layer 232 is moved to a side far away from the first transparent electrode layer 233, the insulating solvent 2322 absorb light rays, such that the corresponding sub-pixel region 2321 displays dark. Therefore, the electrophoretic display module 23 is used as a monochrome display module.

The advantages of the color display device 20 of the present embodiment are similar to those of the color display device 10 of the first exemplary embodiment, and are omitted herein.

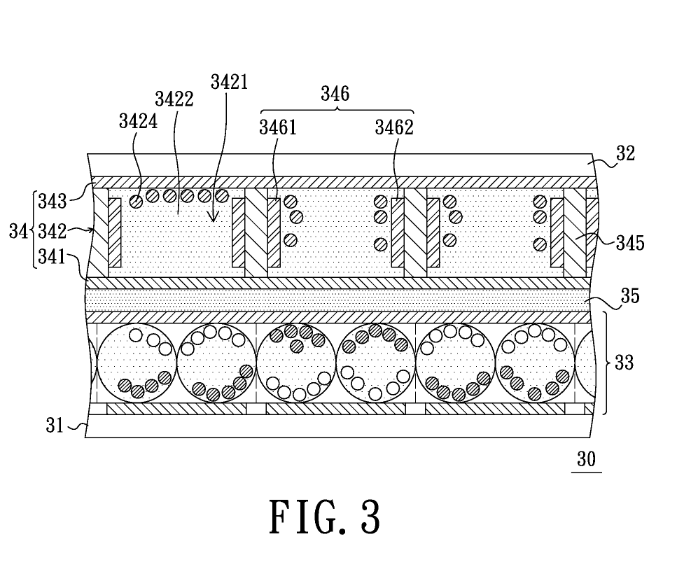

FIG. 3 is a schematic view of a color display device in accordance with a third exemplary embodiment of the present invention. FIG. 3 only shows a pixel structure of the color display device. Referring to FIG. 3, the color display device 30 includes a substrate 31, a protecting layer 32, a monochrome electrophoretic display module 33, a color electrophoretic display module 34 and an insulating layer 35. The insulating layer 35 is made of a transparent material, such as polyethylene terephthalate, polyethylene naphthenate, polyaramid, polyimide, polycycloolefin, polysulfone, epoxy, polycarbonate or polymethylmethacrylate. The protecting layer 32 is opposite to the substrate 31. The substrate 31 may be a rigid substrate or a flexible substrate, and the protecting layer 32 may be a rigid substrate or a protecting film. The protecting layer 32 is made of a transparent material, such as glass or plastic. More specifically, the material of the protecting layer 32 may include polyethylene terephthalate, polyethylene naphthenate, polyaramid, polyimide, polycycloolefin, polysulfone, epoxy, polycarbonate or polymethylmethacrylate. The monochrome electrophoretic display module 33 and the color electrophoretic display module 34 are arranged between the substrate 31 and the protecting layer 32, and the insulating layer 35 is arranged between the monochrome electrophoretic display module 33 and the color electrophoretic display module 34. More specifically, the monochrome electrophoretic display module 33 is disposed on the substrate 31, and the color electrophoretic display module 34 is arranged between the insulating layer 35 and the protecting layer 32.

In the present exemplary embodiment, the monochrome electrophoretic display module 33 may be a microcapsule electrophoretic display module, and the color electrophoretic display module 34 may be a microcup electrophoretic display module. In other exemplary embodiment, the monochrome electrophoretic display module 33 may be a microcup electrophoretic display module, and the color electrophoretic display module 34 may be a microcapsule electrophoretic display module.

In the present exemplary embodiment, the monochrome electrophoretic display module 33 may be the electrophoretic display module 13 as shown in FIG. 1. The color electrophoretic display module 34 includes a driving circuit layer 341, an electrophoretic display layer 342 and a transparent electrode layer 343. The driving circuit layer 341 is disposed on the insulating layer 35. The electrophoretic display layer 342 is disposed on the driving circuit layer 341. The transparent electrode layer 343 is arranged between the electrophoretic display layer 342 and the protecting layer 32.

The electrophoretic display layer 343 is a color electrophoretic display layer, and includes a plurality of partition walls 345, a plurality of insulating solvents 3422 and a plurality of color charged particles 3424. The partition walls 345 are disposed on the driving circuit layer 341 to form a plurality of pixel regions of the driving circuit layer 341. Each of the pixel regions includes a plurality of sub-pixel regions. For the explanation's convenience, FIG. 3 only shows one of the pixel regions, and each of the pixel regions may includes three sub-pixel regions 3421. The insulating solvents 3422 are disposed in the pixel regions respectively. The color charged particles 3424 are dispersed in the insulating solvents 3422 of each pixel region. Each of the sub-pixel regions 3421 has at least one of the color charged particles with same color dispersed therein, and the colors of the color charged particles 3424 in the sub-pixel regions 3421 of each of the pixel regions are different.

The colors of the color charged particles 3424 include red, blue and green, and each of the sub-pixel regions 3421 includes at least one of the color charged particles with same color. In other words, each of the pixel regions includes a red sub-pixel region 3421, a blue sub-pixel region 3421 and a green sub-pixel region 3421. In another exemplary embodiment of the present invention, the colors of the color charged particles 3424 of each of the pixel regions include yellow, cyan and magenta. In other words, each of the pixel regions includes a yellow sub-pixel region 3421, a cyan sub-pixel region 3421 and a magenta sub-pixel region 3421.

In the present exemplary embodiment, the color electrophoretic display module 34 may further includes a plurality of side electrode sets 346 arranged in the sub-pixel regions 3421 of each of the pixel regions. Each of the side electrode sets 346 includes a first electrode 3461 and a second electrode 3462 disposed on the partition walls 345, and the first electrode 3461 is opposite to the second electrode 3462.

When an electric field is applied between the side electrode set 346 in one of the sub-pixel regions 3421, the color charged particles 3424 are moved to the first electrode 3461 and the second electrode 3462, such that the sub-pixel region of the monochrome electrophoretic display module 33 below the sub-pixel region 3421 is exposed. In other words, when the color charged particles 3424 of the sub-pixel region 3421 are moved to the first electrode 3461 and the second electrode 3462, white or black is displayed. When an electric field is applied between the transparent electrode layer 343 and the driving circuit layer 341, the color charged particles 3424 of the sub-pixel region 3421 are moved to near the transparent electrode layer 343, and thus the color of the color charged particles 3424 of the sub-pixel region 3421 is displayed.

Compared with the prior art, since the color display device 30 of the present embodiment has the color electrophoretic display module 34, the color display device 30 does not need the color filter. Therefore, the light utilization efficiency of the color display device 30 of the present embodiment is improved, and the color display device 30 of the present embodiment has high color saturation and high contrast.

In summary, the color display device of the embodiments of the present invention employs the electrowetting display module or the color electrophoretic display module as the color display module, and does not employ the color filter. Therefore, the color display module of the embodiments of the present invention has high color saturation and high contrast.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A color display device, comprising:
a substrate;
a protecting layer opposite to the substrate, the protecting layer being made of a transparent material;
an electrophoretic display module arranged between the substrate and the protecting layer, and the electrophoretic display module being a monochrome display module;
an electrowetting display module arranged between the substrate and the protecting layer, and the electrowetting display module being a color display module; and
a first insulating layer arranged between the electrophoretic display module and the electrowetting display module, and the first insulating layer being made of a transparent material.

2. The color display device as claimed in claim 1, wherein the electrophoretic display module is disposed on the substrate, and the electrowetting display module is arranged between the first insulating layer and the protecting layer.

3. The color display device as claimed in claim 2, wherein the electrophoretic display module comprises:
a first driving circuit layer disposed on the substrate;
an electrophoretic display layer disposed on the first driving circuit layer; and
a first transparent electrode layer arranged between the electrophoretic display layer and the first insulating layer.

4. The color display device as claimed in claim 3, wherein the electrophoretic display layer is one of a microcapsule electrophoretic display layer and a microcup electrophoretic display layer.

5. The color display device as claimed in claim 2, wherein the electrowetting display module comprises:
a second driving circuit layer disposed on the first insulating layer;
a second insulating layer disposed on the second driving circuit layer;
a hydrophobic layer disposed on the second insulating layer;
an electrowetting display layer disposed on the hydrophobic layer; and
a second transparent electrode layer arranged between the electrowetting display layer and the protecting layer.

6. The color display device as claimed in claim 5, wherein the electrowetting display layer comprises:
a matrix layer disposed on the hydrophobic layer to form a plurality of pixel regions on the hydrophobic layer, and the matrix layer being made of a hydrophilic material;
a plurality of polar solvents disposed in the pixel regions; and
a plurality of color pigments disposed in the pixel regions, wherein the color pigments are not soluble in the polar solvents.

7. The color display device as claimed in claim 6, wherein the electrowetting display layer further comprising a plurality of partition walls disposed in the pixel regions to divide each of the pixel regions into a plurality of sub-pixel regions, wherein each of the sub-pixel regions has at least one of the color pigments with same color, and colors of the color pigments of the sub-pixel regions of each of the pixel regions are different.

8. The color display device as claimed in claim 7, wherein the colors of the color pigments of the sub-pixel regions of each of the pixel regions comprise red, blue and green.

9. The color display device as claimed in claim 7, wherein the colors of the color pigments of the sub-pixel regions of each of the pixel regions comprise yellow, cyan and magenta.

10. The color display device as claimed in claim 7, wherein the second driving circuit layer comprises a plurality of driving elements and a plurality of sub-pixel electrodes, and the sub-pixel electrodes are transparent electrodes.

11. The color display device as claimed in claim 1, wherein the substrate is one of a rigid substrate and a flexible substrate.

12. The color display device as claimed in claim 1, wherein the protecting layer is one of a protecting film and a rigid substrate.

13. A color display device, comprising:
a substrate;
a protecting layer opposite to the substrate, the protecting layer being made of a transparent material;
a monochrome electrophoretic display module arranged between the substrate and the protecting layer;
a color electrophoretic display module arranged between the substrate and the protecting layer; and
an insulating layer arranged between the monochrome electrophoretic display module and the color electrophoretic display module, and the insulating layer being made of a transparent material.

14. The color display device as claimed in claim 13, wherein the monochrome electrophoretic display module is a microcapsule electrophoretic display module, and the color electrophoretic display module is a microcup electrophoretic display module.

15. The color display device as claimed in claim 14, wherein the color electrophoretic display module comprises:
a driving circuit layer disposed on the insulating layer;
an electrophoretic display layer disposed on the driving circuit layer, the electrophoretic display layer comprising:
a plurality of partition walls disposed on the driving circuit layer to form a plurality of pixel regions on the driving circuit layer, and each of the pixel regions comprising a plurality of sub-pixel regions;
a plurality of insulating solvents disposed in the pixel regions; and
a plurality of color charged particles dispersed into the insulating solvents disposed in the pixel regions, each of the sub-pixel regions having at least one of the color charged particles with same color disposed therein, and colors of the color charged particles of the sub-pixel regions of each of the pixel regions being different; and
a transparent electrode layer arranged between the electrophoretic display layer and the protecting layer.

16. The color display device as claimed in claim 15, wherein the color electrophoretic display module further comprises a plurality of side electrode sets disposed in the sub-pixel regions of each of the pixel regions respectively, each of the side electrode set includes a first electrode and a second electrode arranged on the partition walls respectively, and the first electrode is opposite to the second electrode.

17. The color display device as claimed in claim 15, wherein the colors of the color charged particles comprise red, blue and green.

18. The color display device as claimed in claim 15, wherein the colors of the color charged particles comprise yellow, cyan and magenta.

19. The color display device as claimed in claim 13, wherein the monochrome electrophoretic display module is disposed on the substrate, and the color electrophoretic display module is arranged between the insulating layer and the protecting layer.

20. The color display device as claimed in claim 13, wherein the substrate is one of a rigid substrate and a flexible substrate, and the protecting layer is one of a rigid substrate and a protecting film.
